(19) United States
(12) Patent Application Publication
(10) Pub. No.: US 2008/0030688 A1
(43) Pub. Date: Feb. 7, 2008

(54) PROJECTION APPARATUS

(75) Inventor: Ching-Po Lee, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/768,184

(22) Filed: Jun. 25, 2007

(30) Foreign Application Priority Data
Aug. 2, 2006 (TW) 95128258

(51) Int. Cl. G03B 21/16

(52) U.S. Cl. 353/54

(57) ABSTRACT

A projection apparatus including an illumination system, a reflective light valve, an imaging system, a loop heat pipe and a heat sink is provided. The illumination system is capable of providing a light beam and the reflective light valve is disposed on the transmission path of the light beam to convert the light beam into an image. The loop heat pipe includes an evaporator, a wick structure, at least a connecting pipe and working fluid. The evaporator includes a fluid backflow end and a vapor exhaust end, and the outer surface of the evaporator is connected to the reflective light valve. A wick structure is disposed inside the evaporator and connected with the fluid backflow end. The connecting pipe is connected between the fluid backflow end and the vapor exhaust end. The working fluid is located in the connecting pipe and the wick structure.

### CROSS-REFERENCE TO RELATED APPLICATION

This application claims the priority benefit of Taiwan application serial no. 95128258, filed Aug. 2, 2006. All disclosure of the Taiwan application is incorporated herein by reference.

### BACKGROUND OF THE INVENTION

1. Field of the Invention

The present invention relates to a projection apparatus, in particular, a projection apparatus which has a better heat dissipating efficiency.

2. Description of Related Art

Referring to FIG. 1, a conventional Digital Light Processing (DLP) projection apparatus 100 includes an illumination system 110, a digital micro-mirror device (DMD) 120 and an imaging system 130. The illumination system 110 has a light source 112 capable of emitting an illumination light beam 114. The digital micro-mirror device (DMD) 120 is disposed on the transmission path of the illumination light beam 114 to convert the illumination light beam 114 into an image light beam 122. In addition, the imaging system 130 is disposed on the transmission path of the image light beam 122 so that the image light beam 122 can be projected on a screen (not shown) to display an image.

Along with the increasing power of the light source 112, the operating temperature of the digital micro-mirror device (DMD) 120 increases. While the digital micro-mirror device (DMD) 120 works under the condition of high temperature, it causes problems like the lifetime of the device decreasing and the image display quality of the DLP projection apparatus 100 degrading. Therefore, it has become a very important issue for research and development to decrease the operating temperature of the digital micro-mirror device (DMD) 120.

In the conventional DLP projection apparatus 100, a high-speed cooling fan and a heat sink is used to dissipate the heat accumulated during the operation of the digital micro-mirror device (DMD) 120 so as to prevent the digital micro-mirror device (DMD) 120 from being over-heated. The thermal resistance produced by the high-speed cooling fan and the heat sink is around the range of 2° C./W to 5° C./W, in order to achieve a lower thermal resistance, a plurality of fins are formed on the heat sink, resulting a huge and bulky heat dissipation module. When the accumulated heat is increasing (the higher heat density) to a degree that the heat dissipation module having the high-speed cooling fan and the heat sink with fins can no longer satisfy the heat dissipation requirement, a high-speed cooling fan and a heat pipe is used to dissipate the heat accumulated around the digital micro-mirror device (DMD) 120. The heat pipe shown in FIG. 2 will be described in detail as follows.

Referring to FIG. 2, the conventional heat pipe 200 includes an evaporating end 210, a condensing end 220, a wick structure 230 and a working fluid 240. One end of the heat pipe 200 is the evaporating end 210 and the opposite end is the condensing end 220. The wick structure 230 is disposed on the inner walls of the heat pipe 200 and the working fluid 240 is located inside the heat pipe 200. The evaporating end 210 is attached to the rear surface of the digital micro-mirror device (DMD) 120 to conduct the heat Q generated during the operation of the digital micro-mirror device (DMD) 120, and the condensing end 220 is connected to a heat sink 250 which is cooled down by the forced heat convection produced by the high-speed cooling fan. When the heat Q generated during the operation of the digital micro-mirror device (DMD) 120 is conducted to the evaporating end 210 of the heat pipe 200, the working fluid 240 located inside the heat pipe absorbs the heat Q and evaporates into vapor 240′, and the vapor 240′ flows towards the condensing end 220. When the vapor 240′ reaches the condensing end 220 to be condensed into a fluid, the heat carried by the vapor 240′ is conducted to the heat sink 250 from the condensing end 220. The working fluid 240 generated at the condensing end 220 is transported back to the evaporating end 210 through the wick structure 230 so that the working fluid 240 is repeatedly evaporated in the evaporating end 210 and condensed in the condensing end 220. As shown in FIG. 2, the wick structure 230 disposed on most part of the inner walls of the heat pipe 200 will be damaged when the heat pipe is bent or pressed, which prevents the working fluid 240 generated at the condensing end 220 to be effectively transported back to the evaporating end 210 and further affecting the heat dissipation efficiency of the heat pipe 200. Moreover, when the condensing end 220 located under the evaporating end 210 of the heat pipe 200, it is hard for the vapor 240′ generated at the evaporating end 210 to flow downward to the condensing end 220 as well as for the working fluid 240 generated at the condensing end 220 to be transported by the wick structure 230 along the direction against gravity. Therefore, the working fluid 240 can not be transported back to the evaporating end 210 effectively. A plurality of heat pipes are often used in the heat dissipation module with large capability of heat dissipation because each one of the heat pipes has limited capability of heat dissipation.

Besides the heat dissipation module discussed above, coolant is often used to lower the temperature of the digital micro-mirror device (DMD) 120. In general, the thermal resistance produced by the heat sink with coolant is around the range of 0.3° C./W to 0.5° C./W. However, the lifetime of the pump to circulate the working fluid is limited, and a tank is often needed to store the working fluid in the above described heat dissipation device which often increases the manufacturing cost.

Take the DLP projection apparatus 100 with output power about 8000 lumen as an example, when the light of the illumination system 110 is projected on the digital micro-mirror device (DMD) 120, the heat Q generated on the digital micro-mirror device (DMD) 120 (with 0.7 inch chip) is around 50 waft. The temperature of the substrate of the digital micro-mirror device (DMD) 120 must be lower than 45° C. in order to maintain the operating temperature of lower than 65° C. for the micro-mirror array disposed on the digital micro-mirror device (DMD) 120. Assuming the operating temperature of the DLP projection apparatus 100 is between 25° C. to 35° C., the thermal resistance of the heat dissipation module for the digital micro-mirror device (DMD) 120 must be lower than 0.2° C./W in order to achieve the temperature of the substrate of the digital micro-mirror device (DMD) 120 to be lower than 45° C. To achieve the thermal resistance lower than 0.2° C./W, a plurality of heat pipe 200 are needed to be employed simultaneously. However, it is somewhat difficult to dispose the plurality of heat pipes 200 on the rear surface of the digital micro-mirror device (DMD) 120 simultaneously.

### SUMMARY OF THE INVENTION

The present invention provides a projection apparatus with improved heat dissipation efficiency.

As embodied and broadly described herein, an embodiment of the present invention provides a projection apparatus which includes an illumination system, a reflective light valve, an imaging system, a loop heat pipe and a heat sink. The illumination system is capable of providing an illumination light beam and the reflective light valve is disposed on the transmission path of the illumination light beam to convert the illumination light beam into an image light beam. The loop heat pipe includes an evaporator section, a wick structure, at least a connecting pipe and working fluid. The evaporator section includes a fluid backflow end and a vapor exhaust end, and the outer surface of the evaporator section is in contact with the reflective light valve. The wick structure is disposed inside the evaporator section and connected with the fluid backflow end. The connecting pipe is connected between the fluid backflow end and the vapor exhaust end. The working fluid is located in the connecting pipe and the wick structure.

Because the loop heat pipe with lower thermal resistance is used to dissipate the heat of the reflective light valve, the operating temperature of the reflective light valve can be lowered. Moreover, since the connecting pipe of the loop heat pipes can be bent in any shape and thus better heat dissipation efficiency can be obtained by fitting the pipes into the space of the projection apparatus and working with different types of heat sinks.

Other objectives, features and advantages of the present invention will be further understood from the further technology features disclosed by the embodiments of the present invention wherein there are shown and described preferred embodiments of this invention, simply by way of illustration of modes best suited to carry out the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a prior art DLP projection apparatus.

FIG. 2 shows a conventional heat pipe.

FIG. 3 shows a projection apparatus according to an embodiment of the present invention.

FIG. 4 is an enlarge view of the loop heat pipes and the reflective light valve in FIG. 3.

FIG. 5 shows a cross-sectional view of the loop heat pipes along I-I′ in FIG. 4.

FIG. 6 shows another type of the projection apparatus according to a second embodiment of the present invention.

FIG. 7˜FIG. 9 show the different types of pipes according to various embodiments of the present invention.

FIG. 10 and FIG. 11 show the schematic views of different types of heat sinks to be incorporated with the loop heat pipes.

FIG. 12 shows the cross-sectional view of an assembly of the evaporator and the heat dissipation fins.

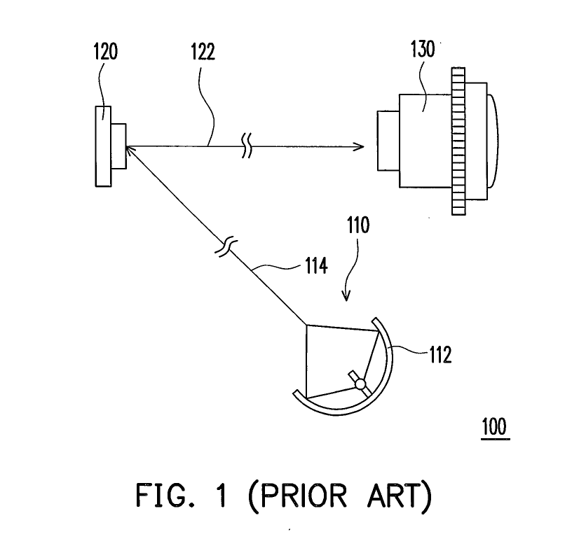

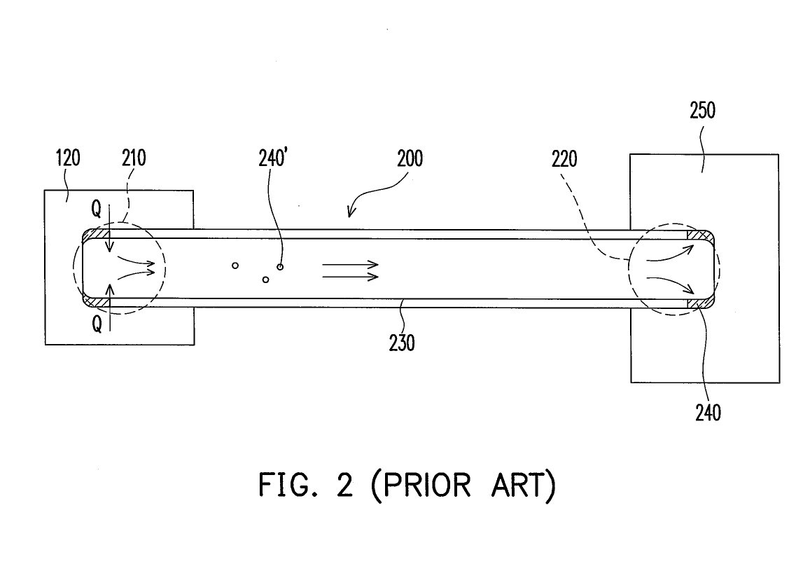

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “over,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “contact with,” and variations thereof herein are used broadly and encompass direct and indirect connections, contacts. Accordingly, the drawings and descriptions will be regarded as illustrative in nature and not as restrictive.

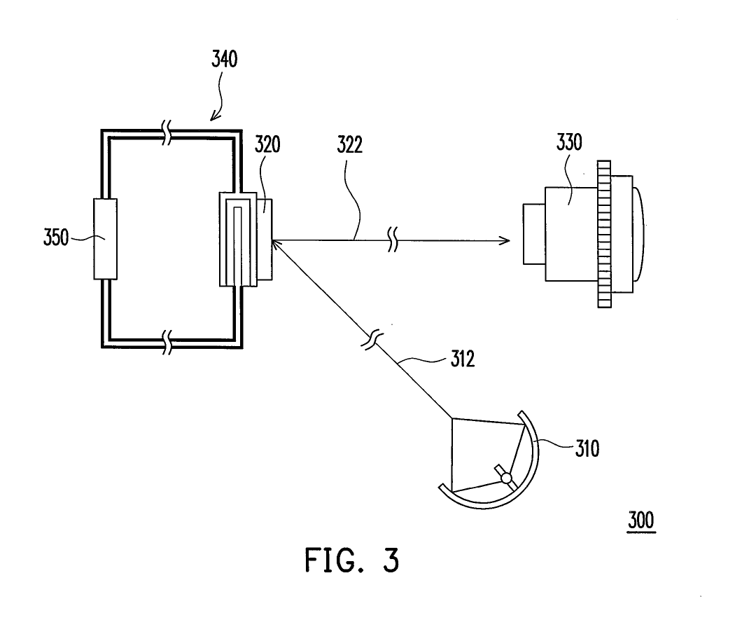

As shown in FIG. 3, the projection apparatus 300 of the embodiment includes an illumination system 310, a reflective light valve 320, an imaging system 330, a loop heat pipe device 340 and a heat sink 350. The illumination system 310 is capable of providing an illumination light beam 312, and the reflective light valve 320 is disposed on the transmitting path of the illumination light beam 312 to convert the illumination light beam 312 into an image light beam 322. The imaging system 330 is disposed on the transmitting path of the image light beam 322 so as to project the image light beam 322 onto a screen (not shown). A detailed description of the loop heat pipe 340 is described as follow.

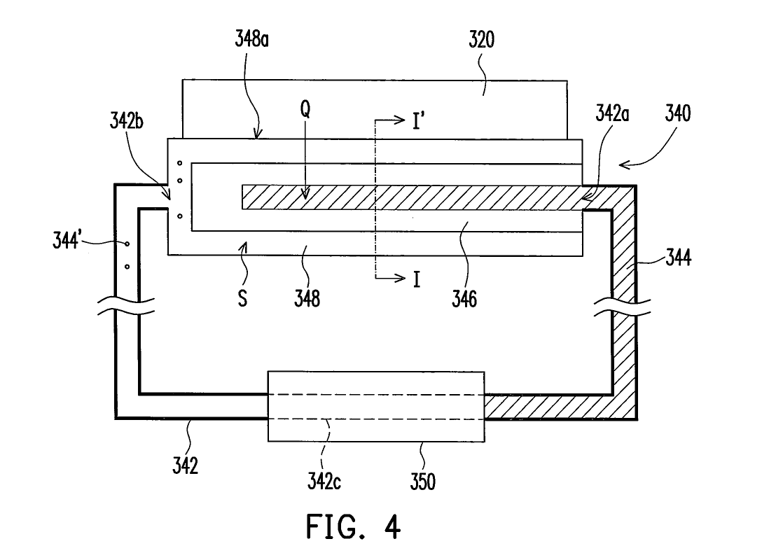

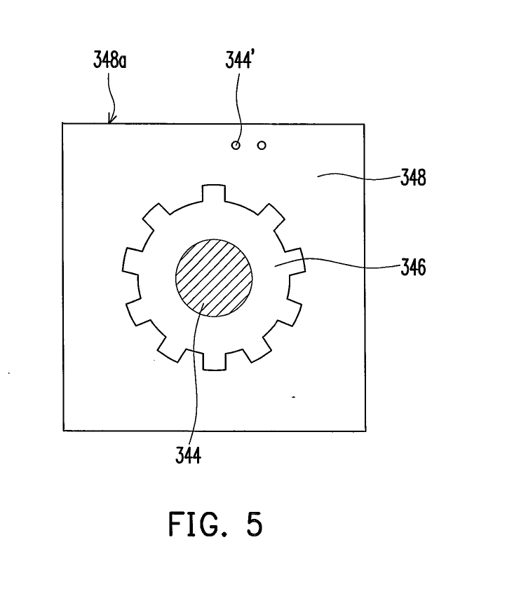

Referring to FIGS. 4 and 5, the loop heat pipe 340 of the present embodiment includes a evaporator section 348, a wick structure 346, at least one connecting pipe 342 (only one connecting pipe shown in the FIG. 4) and a working fluid 344. The evaporator section 348 has a fluid backflow end 342a and a vapor exhaust end 342b, and the outer surface 348a of the evaporator section 348 is contact with the reflective light valve 320. The wick structure 346 is located inside of the evaporator section 348 and connected to the fluid backflow end 342a. The connecting pipe 342 is connected between the fluid backflow end 342a and the vapor exhaust end 342b and the connecting pipe 342 has a condenser section 342c. As shown in FIG. 4, the heat sink 350 is connected to the condenser section 342c of the connecting pipe 342 so as to lower the temperature of the connecting pipe 342 in the loop heat pipe 340. The working fluid 344 is located inside the connecting pipe 342 and the wick structure 346.

Referring to FIG. 4, since the outer surface 348a of the evaporator section 348 is contact with the reflective light valve 320, the heat Q accumulated at the reflective light valve 320 is conducted to the wick structure 346 through the outer surface 348a and the evaporator section 348. Then the working fluid 344 permeates to the wick structure 346 and absorbs the heat Q so as to evaporate into vapor 344′ in the inner space S of the evaporator section 348. The vapor 344′ generated in the inner space S increases the vapor pressure of the inner space S and the connecting pipe 342 and thus facilitating the working fluid 344 to flow in the connecting pipe 342. The driving force that facilitating the working fluid 344 to flow in the loop heat pipe 340 is due to the increasing vapor pressure of the vapor 344 and the draw phenomenon (capillarity) in wick structure 346. Under the effects of the two driving forces, the heat dissipating capability of the loop heat pipe 340 in this embodiment will not substantially be affected by gravity and thus can be assembled in any direction depending on the needs.

The working fluid 344 in the connecting pipe 342 may flow into the evaporator section 348 through the fluid backflow end 342a. After the working fluid 344 being evaporated, the vapor 344′ flows into the connecting pipe 342 through the vapor exhaust end 342b. And after the vapor 344′ flows a distance in the connecting pipe 342, the heat Q is conducted to the condenser section 342c of the connecting pipe 342 and the heat sink 350. The vapor 344′ is cooled down and condensed into the working fluid 344, which results in that the working fluid 344 may dissipate heat generated from the reflective light valve continuously.

The reflective light valve 320 may be digital micro-mirror device (DMD) or liquid crystal on silicon (LCOS) in any size. In general, if the size of the reflective light valve 320 is very small, for example, 0.7 inch, 0.55 inch or even smaller, the thermal resistance of the heat dissipation module must be small enough to dissipate the heat Q accumulated in the reflective light valve 320 efficiently. In the loop heat pipe 340 of present embodiment, the thermal resistance from the reflective light valve 320 to the evaporator section 348 is about 0.1° C./W and the thermal resistance from the reflective light valve 320 to external environment is about 0.2° C./W. Therefore, the loop heat pipe 340 has enough capability to dissipate the heat accumulated at the reflective light valve 320. In addition, the shape and size of the evaporator section 348 may be designed to match the shape and size of the reflective light valve 320 so that the evaporator section 348 may be connected to the rear surface of the reflective light valve 320 to further reduce the thermal resistance from the reflective light valve 320 to the evaporator section 348.

Accordingly, the evaporation temperature of the working fluid 344 is, for example, between 20° C. to 60° C. In a preferred embodiment of the present invention, the working fluid 344 is, for example, water or other fluid which is easily to be evaporated.

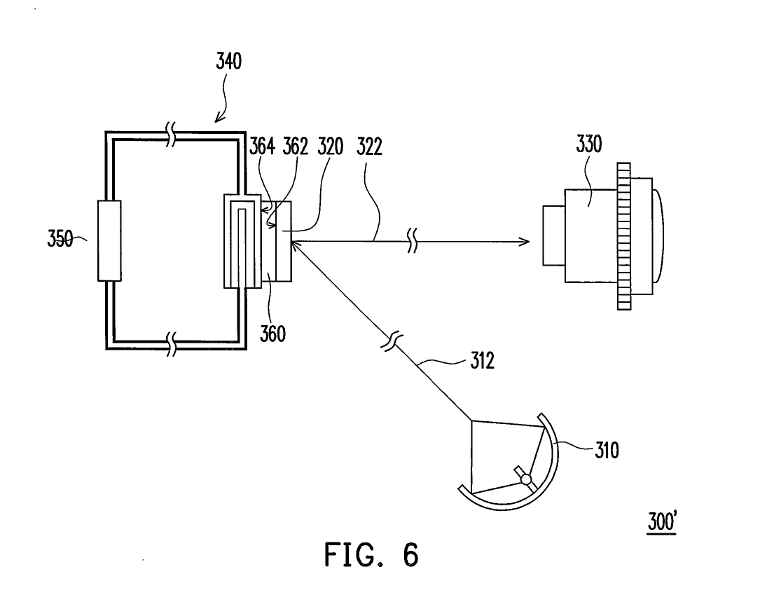

Referring to FIG. 6, the projection apparatus 300′ further includes a thermoelectric cooling device 360 disposed between the reflective light valve 320 and the loop heat pipe 340. The thermoelectric cooling device 360 has a low-temperature end 362 and a high-temperature end 364. The low-temperature end 362 of the thermoelectric cooling device 360 is contact with the rear surface of the reflective light valve 320 and the loop heat pipe 340 is contact with the high-temperature end 364 of the thermoelectric cooling device 360.

In case of a condenser section design with a large heat-dissipating area, the length of the connecting pipe 342 is altered and the connecting pipe 342 is distributed evenly over the heat sink 350 so as to increase the heat exchange rate between the vapor 344′ within the condenser section 342c and the heat sink 350. Therefore, the vapor 344 flowed in the connecting pipe 342 can be condensed into the working fluid 344 completely. Various types of connecting pipe 342 are discussed below.

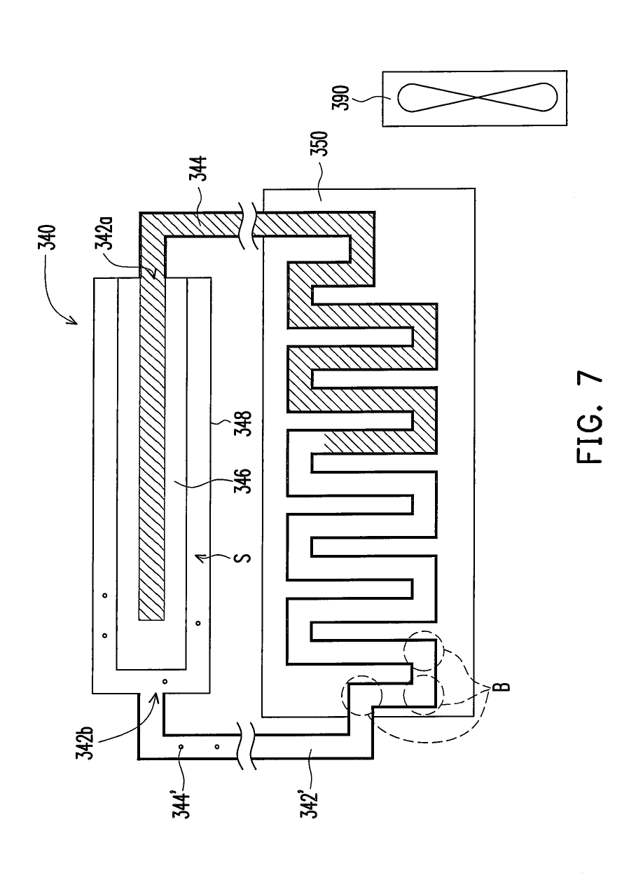

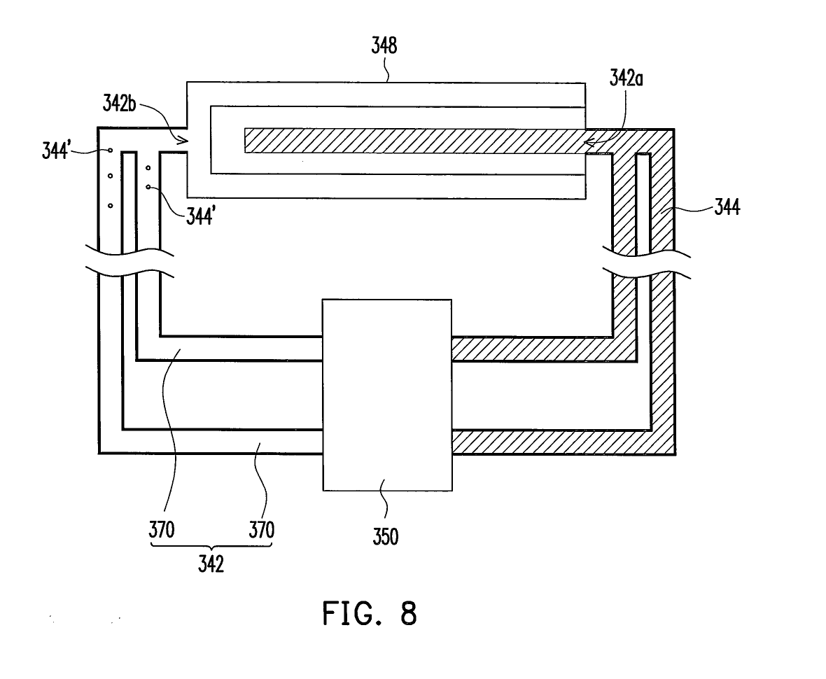

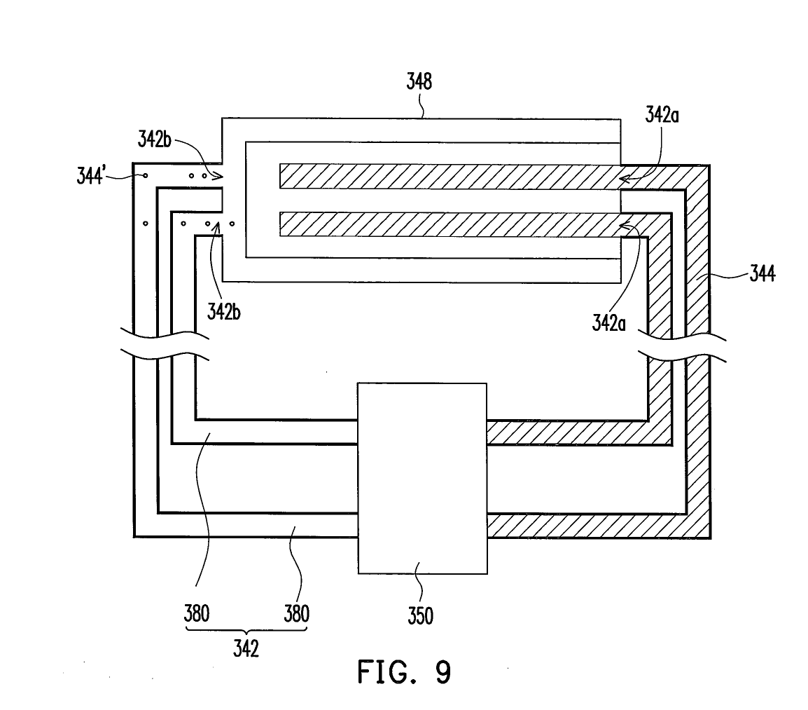

Referring to FIG. 7, in order to increase the contact surface of the connecting pipe 342 with the heat sink 350, the connecting pipe 342 can be bent to form a plurality of turnings B. The heat Q of the vapor 344′ in the connecting pipe 342′ is conducted to the heat sink 350 and external environment more effectively. In addition, in the present embodiment, heat accumulated in the heat sink 350 may be dissipated by a cooling fan 390, such that the heat dissipation efficiency of the loop heat pipe 340 is further increased.

Referring to FIG. 8, besides the employment of the connecting pipe 342 having the turnings B (shown in FIG. 7), the connecting pipe 342 in different types may be used also. For example, the connecting pipe 342 may include a plurality of sub-pipes 370 that are communicated with each other (as shown in FIG. 8). The working fluid 344 flowed in each sub-pipe 370 may converge before flowing into the evaporator section 348 through the fluid backflow end 342a thereof. After the working fluid 344 being evaporated, the vapor 344′ flows to different sub-pipes 370 through the single vapor exhaust end 342b of the evaporator section 348 such that the heat Q carried by the vapor 344′ in different sub-pipes 370 is simultaneously conducted to the heat sink 350.

Referring to FIG. 9, the connecting pipes 342 may include a plurality of sub-pipes 380 that are not communicated with each other (as shown in FIG. 9), the working fluid 344 flowed in each sub-pipes 380 respectively flows back into the evaporator section 348 through different fluid backflow ends 342a. After the working fluid 344 being evaporated, the vapor 344′ flows to different sub-pipes 380 through the different vapor exhaust ends 342b of the evaporator 348, such that the heat Q carried by the vapor 344′ in different sub-pipes 380 is simultaneously conducted to the heat sink 350.

Accordingly, the connecting pipes 342 as shown in the FIG. 4, FIG. 7, FIG. 8 and FIG. 9 can be entirely made of any material with high thermal conductivity coefficient, such as copper pipes, aluminum pipes. In order to increase the flexibility of the assembly, the material with high thermal conductivity coefficient, such as copper pipes, aluminum pipes (rigid pipes) may be used to contact with the heat sink 350 and the other part of the connecting pipe may use flexible pipes such as plastic pipes, or other flexible pipes.

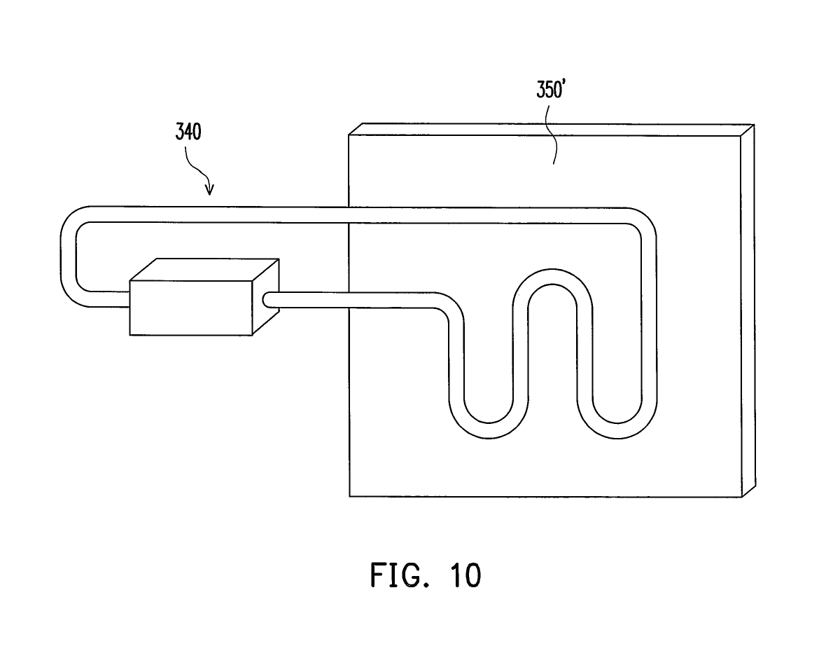

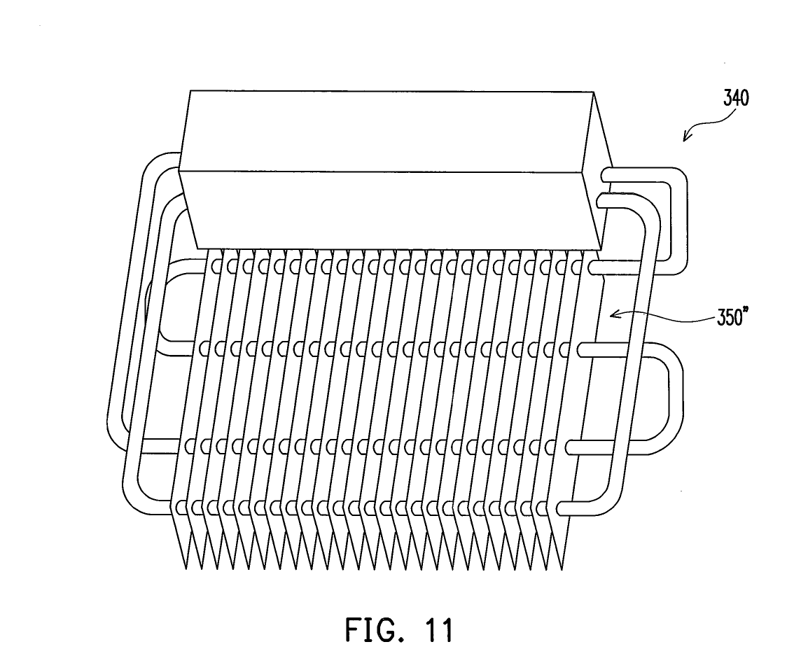

FIG. 10 and FIG. 11 show the schematic views of different types of heat sinks to be incorporated with the loop heat pipes. The above-mentioned loop heat pipe 340 may be used with a heat dissipation plate 350′ (as shown in FIG. 10) or a plurality of heat dissipation fins 350″ (as shown in FIG. 11). Both the heat dissipation plate 350′ and the plurality of heat dissipation fins 350″ are for increasing the contact area which can conduct the heat Q to the external environment effectively.

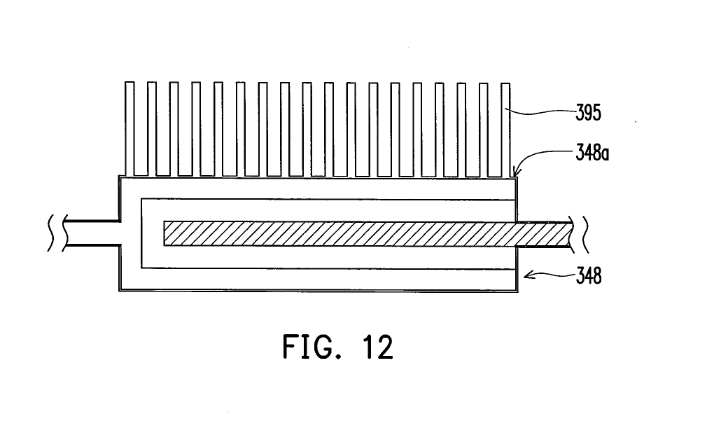

FIG. 12 shows the cross-sectional view of the assembly of the evaporator section and the heat dissipation fins. As shown in FIG. 12, a plurality of heat dissipation fins 395 may be disposed on the outer surface 348a of the evaporator section 348 so as to decrease the temperature of the evaporator section 348. In other words, the heat Q can be conducted directly to external environment by the heat dissipation fins 395 located on the outer surface 348a of the evaporator section 348.

In summary, one or more of advantages of the projection apparatus includes:

1. The loop heat pipe according to an embodiment of the present invention has very low thermal resistance (lower than 0.2° C./W) and thus can decrease the operating temperature of the reflective light valve effectively.

2. In the loop heat pipe according to an embodiment of the present invention, the connecting pipes can be bent in any form without damaging the wick structure therein so as to incorporate with the space design of the projection apparatus.

3. The thermal resistance of the loop heat pipes according to an embodiment of the present invention may not increase substantially while the length of the connecting pipes increases.

4. The loop heat pipes can be disposed in any way and the heat dissipation efficiency will not be affected by the gravity.

5. The loop heat pipes according to an embodiment of the present invention may be used in conditions of high heat density and also possess good heat dissipation efficiency.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
an illumination system for providing an illumination light beam;
a reflective light valve disposed on a transmission path of the illumination light beam to convert the illumination light beam into an image light beam;
an imaging system disposed on a transmission path of the image light beam;
a loop heat pipe including:
an evaporator section having a fluid backflow end and a vapor exhaust end, wherein an outer surface of the evaporator section is in contact with the reflective light valve;
a wick structure disposed inside the evaporator section and connected to the fluid backflow end;
at least a connecting pipe having a condenser section, wherein the connecting pipe is connected to the fluid backflow end and the vapor exhaust end; and
a working fluid located in the connecting pipe and the wick structure; and
a heat sink contacted to the condenser section of the connecting pipe.

2. A projection apparatus as in the claim 1, wherein the reflective light valve comprises a digital micro-mirror device (DMD) or a liquid crystal device of silicon (LCOS).

3. The projector apparatus as in the claim 1, wherein the connecting pipe has a plurality of turnings.

4. The projector apparatus as in the claim 1, wherein the connecting pipe comprises a plurality of sub-pipes communicated with each other.

5. The projector apparatus as in the claim 1, wherein the connecting pipe comprises a plurality of sub-pipes not communicated with each other.

6. The projector apparatus as in the claim 1, wherein the connecting pipe comprises copper pipes or aluminum pipes.

7. The projector apparatus as in the claim 1, wherein the connecting pipe comprises a plurality of rigid pipes and at least a flexible pipe connected to two of the rigid pipes.

8. The projector apparatus according to claim 1, wherein the evaporation temperature of the working fluid is between 20° C. to 60° C.

9. The projector apparatus according to claim 1, wherein the working fluid comprises water.

10. The projector apparatus according to claim 1, wherein a material of the evaporator section comprises copper or aluminum.

11. The projector apparatus according to claim 1, wherein the evaporator section has an inner space and the working fluid permeated in the wick structure is evaporated so as to flow from the inner space to the vapor exhaust end.

12. The projector apparatus according to claim 1, wherein the evaporator section has a heat dissipation fin located on an outer surface thereof.

13. The projector apparatus as in the claim 1, wherein the heat sink comprises a plurality of heat dissipation fins or a heat dissipation plate.

14. The projector apparatus as in the claim 1, further comprising a thermoelectric cooling device disposed between the reflective light valve and the loop heat pipe.

15. The projector apparatus as in the claim 1, further comprising a cooling fan for cooling the heat sink.
